(19) United States
(12) Patent Application Publication
(10) Pub. No.: US 2004/0225733 A1
(43) Pub. Date: Nov. 11, 2004

(54) Multicasting notification system

(76) Inventors: Kaj Tesink, Fair Haven, NJ (US); Joseph E. Clark III, Little Silver, NJ (US); Stephen Walters, Holmdel, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 10/430,140

(22) Filed: May 6, 2003

(51) Int. Cl. G06F 15/173

(52) U.S. Cl. 709/225

(57) ABSTRACT

A message is multicast to recipients by correlating the message at a management system to agents, each agent being responsible for a set of the recipients, and by conveying the message over a network to the correlated agents for transmission to the recipients. The management system maintains recipient lists wherein each list is associated with one or more agents, each agent maintaining a portion of its associated lists. The management system chooses a single recipient list and conveys an indication of the list to its associated agents. Each notified agent accesses the indicated list and sends the message to the listed recipients. In a further embodiment, an independent management system interfaces a plurality of management systems, each with a set of agents. The independent management system chooses a recipient list, the list being associated with a management system and its agents, and conveys the message based on the chosen list.

### FIELD OF THE INVENTION

Our invention relates generally to public notification systems. More particularly, our invention relates to the multicasting of messages to a predetermined set of designated recipients.

### DESCRIPTION OF THE BACKGROUND

When a large scale event occurs, such as a storm or fire, there is need to quickly notify that sector of the public that is directly affected by the event. In addition, the notification needs to instruct the affected sector how to react. Current systems, such as firehouse sirens, can broadcast notifications but these notifications are not specifically directed at the affected public and do not provide detailed information of the event. Other systems use the Public Switched Telephone Network (PSTN) to provide notifications by phone call. Advantageously, these systems can target specific individuals and can provide detailed notifications. Typically, these systems perform automated call-generation and are connected to an originating switch through a set of phone lines. A user of these systems specifies a notification message and a set of recipient phone-numbers. These systems then place phone calls through the PSTN to these recipients. The downside of these systems is that they are limited with respect to the speed in which the designated recipients can be reached. Specifically, these systems have capacity limitations because all designated recipients are contacted by a single system that originates calls from a central location to destinations across the PSTN (i.e., inter-switch calls). In addition to the limitations of the systems themselves, the PSTN is a bottleneck due to the capacity limitations and call delays associated with the originating switch, inter-office trunk lines, the signaling systems, and inter-office call delays. Thus, current systems do not allow high volumes of notifications within a short period of time.

### SUMMARY OF OUR INVENTION

Accordingly, it is desirable to provide methods and systems that overcome the shortcomings of the prior art and more efficiently multicast notification messages to the subscribers of a communications network. In accordance with a first embodiment of our invention, a plurality of PSTN-based agents are associated with and telephonically connected to the end-office switches within a PSTN service provider network. Each agent is responsible for/controls the subscribers (which we refer to as recipients) serviced by the end-office switch(es) to which the agent is connected. In addition, each agent is associated with/controlled by a management system and interfaces this management system through a data network.

During a maintenance process, a list administrator creates master recipient lists at the management system wherein each list specifies a set of recipients (i.e., subscribers) of the PSTN network. These lists are stored at the management system. The management system in turn decomposes each master recipient list into sub-lists of recipients, wherein each sub-list corresponds to an agent and includes recipients within that agent's scope of control. The management system downloads each sub-recipient list to its corresponding agent and maintains an association between each master recipient list and the agents that contain a portion of this list.

When a notification event occurs, a notification initiator chooses a master recipient list. The management system correlates the chosen list to the agent(s) associated with the list and sends these agent(s) an indication specifying the chosen list. Each notified agent in turn accesses its local sub-list and multicasts the message to each of the listed recipients. Advantageously, because a plurality of agents are placed throughout the telephony network at the end-office switches and because calls are originated from these agents, our inventive system multicasts messages to recipients bypassing the bottlenecks associated with inter-office call delays, switch blocking, and the bottlenecks associated with a single call origination point.

In accordance with a second embodiment of our invention, one or more email-based agents is interfaced to the management system through the data network. Each email-based agent is associated with/responsible for a plurality of email subscribers. Similar to above, master recipient lists are created at the management system, these lists now including email subscribers. Again, the management system decomposes each master list into sub-lists based on which agent (PSTN-based agent or email-based gent) controls the recipients and then send each sub-list to its corresponding agent. When a notification event occurs, the notification initiator chooses a master recipient list, which the management system then correlates to both the PSTN and email-based agents based on which agents are responsible for the listed recipients. The management system then sends each determined agent an indication of the chosen master recipient list causing each agent to access is local list and notify the specified recipients. Similarly, our inventive system can comprise one or more short message service (SMS) based agents for notifying SMS subscribers.

In a third embodiment of our invention, a plurality of management systems (each referred to as a dependent management system), each with a distinct set of agents and each associated with a service provider network, are interfaced to one or more independent management systems through a data network. Accordingly, each recipient across the various service provider networks is associated with a dependent management system and an agent. During a maintenance process, a list administrator creates master recipient lists at the independent management system where each list specifies recipients across one or more dependent management systems. The independent management system then decomposes each list into sub-lists based on which dependent management system services the recipients and passes each sub-list to its associated dependent management system. Each dependent management system in turn decomposes its received lists into further sub-lists based on which agents serve the listed recipients (similar to above). Each dependent management system then passes each sub-list to its corresponding agent.

During a notification event, a notification initiator chooses a master recipient list at the independent management system, which correlates this chosen list to the associated dependent management system(s) that contain a portion of this list. The independent management system then sends each correlated dependent management system an indication of the master list. Each dependent management system uses this indication from the independent management system to then choose a list from among its local sub-lists. Each dependent management system then correlates this chosen list to the agent(s) associated with the list and sends these agent(s) an indication specifying the chosen list. Each notified agent in turn accesses its local sub-list and multicasts the message to each of the specified recipients.

### BRIEF DESCRIPTION OF THE DRAWINGS

FIG. 1 depicts a first illustrative embodiment of our inventive notification system comprising a plurality of agents each assigned to and telephonically connected to an end-office switch of a PSTN network and comprising a management system interfaced to the agents through a data network, wherein the management system multicasts a message to the subscribers of the PSTN network by sending a multicast requests to one or more agents, wherein the multicast request includes an indication of a predefined list of subscribers maintained at the agent specifying which subscribers are to receive the message, and wherein an agent initiates calls and delivers the message to the subscribers specified in the indicated list.

FIG. 2A depicts an illustration of the agent of our first embodiment, the agent comprising a plurality of telephony interfaces for interfacing an end-office switch, a plurality of call processors for initiating simultaneous calls to the subscribers of its connected switch, and comprising a plurality of pre-defined recipient lists specifying varying sets of subscribers that may receive a message based on a multicast request received from the management system.

FIG. 2B shows an illustrative example of the recipient lists of our invention, wherein the management system maintains a global view of the recipient lists and each agent within the management system's domain maintains a portion of these lists.

FIG. 3 depicts the operation of the agent upon receiving a multicast request from the management system.

FIG. 4 depicts an illustration of the management system of our first embodiment, the management system comprising an interface for accessing a local number portability database to resolve ported numbers, a network interface for communicating with agents, agent records for maintaining an association between an agent and the switches the agent serves, and pre-defined recipient lists.

FIG. 5 depicts the operation of the management system for sending a multicast request to one or more agents.

FIG. 6 depicts a second illustrative embodiment of our inventive notification system, the system comprising PSTN-based agents for multicasting a message to PSTN-based subscribers, email-based agents for multicasting the message through email to email-based subscribers, and short message service (SMS) based agents for multicasting the message through SMS-based systems to SMS-based subscribers, wherein the management system interfaces the varying media-based agents through a data network, and wherein the management system multicasts the message to the varying subscribers of each media by sending a multicast request to one or more agents providing an indication of which subscribers are to receive the message.

FIG. 7 depicts a third illustrative embodiment of our inventive notification system, the system comprising one or more independent management systems and a plurality of sub-notification systems of the first and second embodiments, wherein each sub-notification system is connected to the independent management systems through a data network, wherein each sub-notification system covers a domain of subscribers, and wherein each independent management system multicasts a message to subscribers across the varying domains by sending a multicast request to one or more sub-notification systems providing an indication of which subscribers within the corresponding domain are to receive the message.

FIG. 8 shows an illustrative example of the recipient lists of the third embodiment of our invention, wherein the independent management system maintains a global view of the recipient lists, a dependent management system within each sub-notification system maintains a portion of these lists, and the agents within each sub-notification system maintains a portion of the lists maintained by its management system.

### DETAILED DESCRIPTION OF OUR INVENTION

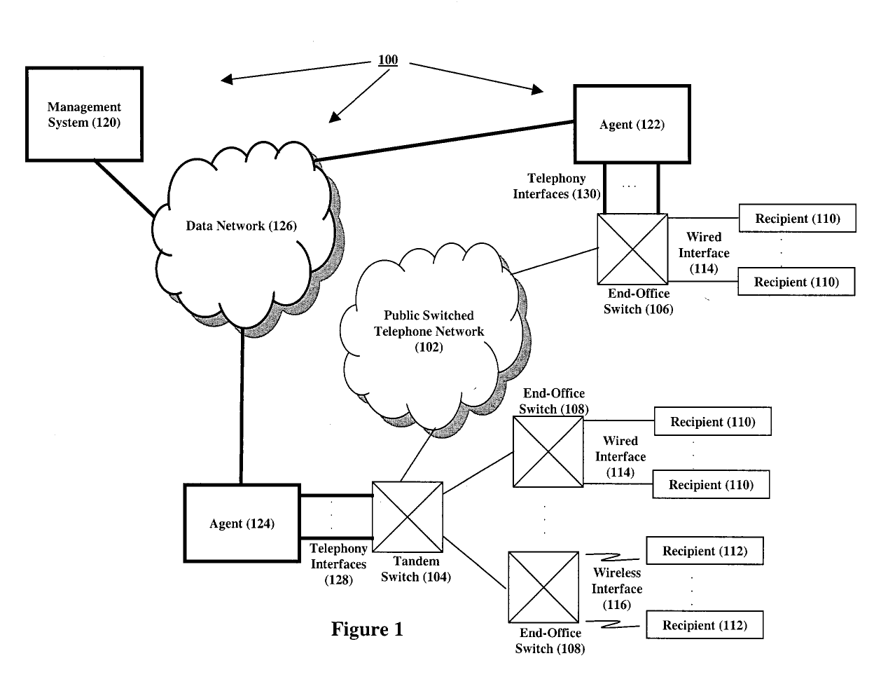

FIG. 1 shows a first illustrative embodiment of notification system 100 of our invention for efficiently multicasting notification messages to both wireless/wired subscribers 110/112 of a Public Switched Telephone Network (PSTN)102, which comprises a plurality of switches such as tandem switch 104 and end-office switches 106/108 (note that an end-office switch 106 could also be a Public Branch Exchange (PBX)). System 100 comprises a management system 120, a plurality of agents 122/124, and a data network 126 that interconnects the management system and plurality of agents. The management system resides at a central processing center. Using one or more telephony interfaces 128/130 (i.e., signaling/bearer access), each agent is connected either directly to an end office switch 106 or indirectly to a plurality of end-office switches 108 through a tandem switch 104. As is known, each end-office switch 106/108 has an associated set of subscribers 110/112, which are the intended “recipients” of the notification messages that system 100 multicasts. Each agent is assigned to the recipients 110/112 that are served by the end-office switch(es) to which the agent is connected. In accordance with our invention, a notification initiator accesses the management system 120 and specifies a message (such as a voice message) and a set of recipients 110/112 that should receive this message. The management system then correlates the designated recipients with their associated agents and forwards a multicast request to these agents through the data network 126 (the multicast request includes the message to be sent and an indication of the intended recipients). Upon receiving this request, each agent originates a plurality of telephony calls through its corresponding end-office switch to its associated recipients that are intended to receive the message and delivers the message over this connection.

Because a plurality of agents are placed throughout the telephony network at the end-office switches, system 100 originates calls and distributes messages to the PSTN-based recipients while bypassing the bottlenecks associated with prior systems. Specifically, by having the PSTN-portion of the message-distribution originate and terminate from the same end-office, all calls are local and PSTN signaling delays are avoided. In addition, prior systems attempt to originate numerous PSTN calls from a single originating office to a plurality of end-offices thereby making the originating office's call capacity a bottleneck. By placing agents throughout the network, this bottleneck is distributed and reduced. Reference will now be made in further detail to the methods and apparatus of our invention.

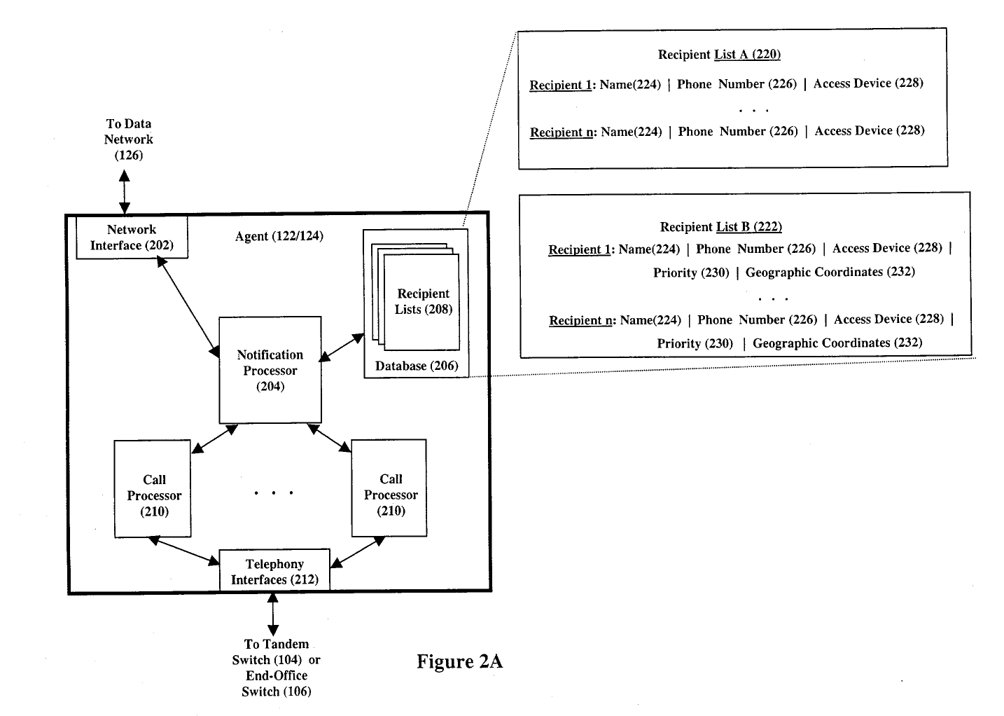

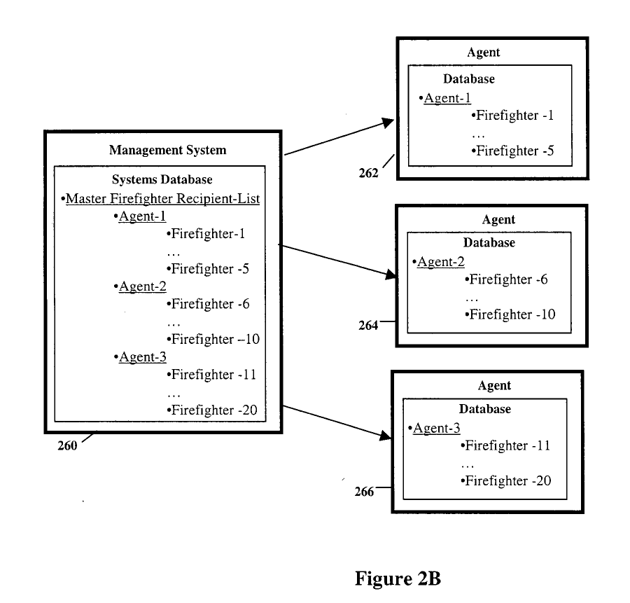

FIG. 2A is a diagram of an agent 122/124. Each agent comprises a network interface 202 for interfacing with the data network 126, a notification processor 204 for processing multicast requests from the management system 120, a database 206 comprising a plurality of recipient lists 208, and a plurality of call processors 210 and telephony interfaces 212 for establishing calls to recipients. As indicated, an agent is associated with one or more end-office switches (or PBX's) and is telephonically connected to its associated switch(es) either directly (as shown with end-office switch 106) or indirectly through a tandem switch 104 (as shown with end-office switches 108). Preferably, the connections are not made through a tandem switch in order to reduce latency during call-setup; however, for rural areas, it is not always economically feasible to associate a single agent with each end-office switch. Regardless of whether the agent interfaces a tandem or end-office switch, the agent is either co-located with its associated switch(es), such as at a central office, or is located at an off-site location. In addition, the agent may be integrated into its associated end-office or tandem switch and operate as part of the switch functionality.

In addition to an associated switch(es), each agent is assigned a set of recipients. Specifically, PSTN-based subscribers are assigned to an end-office switch and interface this switch either through a physical static connection (e.g., copper access) 114 or through a wireless interface 116. In accordance with our invention, each agent 122/124 is assigned to (or is responsible for) the subscribers associated with the end-office switch to which the agent is connected (either directly or indirectly through a tandem switch). We refer to an agent's associated subscribers as recipients. Broadly, these recipients can be referred to as being in the agent's “domain.” An agent's purpose is to receive a multicast request from the management system 120 and to efficiently originate near-simultaneous calls to all or a subset of its assigned recipients and to deliver a message.

An agent communicates with the management system 120 through the data network 126. As further described below, data network 126 can vary and may comprise the CCS/SS7 network, an Ethernet network, a Frame Relay network, etc. Network interface 202 is a standard interface port for interfacing the agent to the data network 126. This interface port is dependent on the type of data network.

The agent establishes calls and communicates with its associated recipients through the call processors 210 and telephony interfaces 212. Specifically, the agent connects to its end-office or tandem switch through the telephony interfaces. The types of interfaces 212 are not specific to our invention and may include ISDN (Integrated Services Digital Network) lines, a plurality of analog lines, T1 interfaces (e.g., when connecting to a tandem switch), etc. Each call processor 210 is an independent module. As such, the call processors can act as a collective unit and simultaneously establish calls and deliver messages to the agent's recipients through the telephony interfaces 212. As a result, the simultaneously executing call processors allow the agent to efficiently originate numerous calls once a multicast request is received from the management system 120.

The number of telephony interfaces and call processors within an agent can vary; for example, an agent's simultaneous call-capacity is limited by the ring capacity of the agent's connected switch. In particular, end-offices are of varying sizes depending on the number of subscribers they serve. However, due to switch capacity, only a percentage of these subscribers can be simultaneously rung. An agent is sized based on the ring capacity of its associated switch(es). For very large switches, an agent may actually comprise multiple units, each of the form as shown in FIG. 2A. For very small end-offices such as in rural areas, it may not be efficient to associate an agent with a single end-office. As indicated, an agent 124 may be associated with several end-offices 108 through a tandem switch 104.

The agent maintains records of the recipients in its domain through sets of pre-defined recipient lists 208. Specifically, in accordance with our invention, system 100 uses a recipient-list-system in order to quickly notify recipients when a notification event occurs. Prior to sending a multicast request (i.e., during a maintenance process), a list administrator interacts with the management system 120 to define different types of recipient lists. For example, a list administrator can define a list specifying all firefighters within each agent's domain. This list can be referred to as a master list and is maintained by the management system. In addition, the management system breaks this master list into a set of sub-lists, where each sub-list corresponds to an agent and includes the recipients within that agent's domain. The management system creates these lists and downloads them to the respective agents during an off-line maintenance process. Each agent stores its sub-lists as recipient lists 208 in database 206. The result is a set of sub-lists at one or more agents wherein the lists are of the same type (i.e., firefighter list) but differ in the specified recipients.

FIG. 2B is an exemplary diagram showing the relationship between the recipient lists maintained at the management system 120 and agents 122/124. In this example, a list administrator has created lists of firefighter's phone numbers. The master recipient list at the management system 260, “Master FireFighter Recipient List,” comprises a plurality of component lists, “Agent-1,” “Agent-2,” and “Agent-3,” each corresponding to an agent 262, 264, and 266 and specifying the firefighters that are within that agent's domain (Note that for example reasons only, the master list at management system 260 is shown as being stored as/composed of the individual sub-lists. However, how the master list is actually stored/arranged is not specific to our invention). Correspondingly, each agent maintains a copy of its component list. When an event occurs, a notification initiator interacts with the management system and specifies a notification event at the management system, such as an indication that all firefighters should be notified. The management system correlates this designation to each of the master recipient lists it maintains in order to choose a list (here, the Master FireFighter Recipient List) and then contacts each of the agents associated with this chosen list (i.e., each agent that has a sub-list that composes the master list). Specifically, the management system sends each agent 262, 264, and 266 a multicast request that includes a message and an indication of the chosen recipient list, such as a list name. Accordingly, each agent accesses the indicated recipient list from its database 206 and sends the message to the firefighters specified in this list.

Note that different types of lists can be simultaneously defined (e.g., lists can also be defined designating only police personnel). As such, at any given agent, a recipient may be present on more than one list. Based on the type of event specified by the notification initiator, the management system will choose different list-types. Note that the types of lists that can be defined are not particular to our invention.

The information maintained in any given list (FIG. 2A shows an exemplary subscriber lists 220 and 222) includes a recipient's name (224), phone number (226), and possibly the recipient's access device (228); in addition, a list may include a priority designation (230) and geographic coordinates (232). Importantly, the management system determines if a recipient has a ported number when creating the master recipient lists and resolves the number at this time, thereby ensuring that the recipient lists at each agent are for recipients served by the agent's corresponding end-office switch. Again, by pre-defining the lists and storing them at the agents, the management system need only specify a list during a multicast request, rather than send each agent an entire list of recipients and phone-numbers. This system saves time during a multicast request and allows a user to specify general criteria as to which recipients should receive a message, letting the notification system 100 then convert these general criteria into specific recipients.

The final component of the agent is notification processor 204, which oversees the operation of the agent 122/124. Specifically, during a notification event, the management system sends an agent a multicast request, which include a message/message type, a delivery mode, and some indication as to which list of recipients 208 should receive the message (Again, the management system does not send the agents actual lists at this time. Rather, it sends an indication as to which master list was chosen. The agent correlates this indication to its pre-stored recipient lists 208 and accesses the recipient list corresponding to the indicated master list.). Based on this multicast request, the notification processor 204 configures the agent to deliver the specified message. In particular, system 100 of our invention can deliver varying message types to recipients including a special ring pattern, pre-recorded text message (intended for ADSI type-subscribers, for example), pre-recorded audio messages, or a text or audio message provided by a user of the management system at the time a notification event occurs. Pre-recorded text and audio messages can be stored at either the management system 120 or at the agent. When the text or audio message originates from the management system (either because it was pre-recorded and stored there or was provided by a user), the message is sent to the agent as part of the multicast request. When a ring pattern or agent-based pre-recorded text/audio message is used, an indication of the message is included in the multicast request. As for audio-based messages, these are preferably compressed (whether delivered by the management system or pre-recorded and stored at the agent) to conserve space and to reduce transmission time over the data network 126 (for example, an 8:1 compression ration can be used). Accordingly, the notification processor will decompress these messages prior to establishing calls to the recipients and sending the message. Because audio-based messages are supported, the agent also comprises digital-to-analog converters for converting the audio message to an analog format for transmission over analog subscriber interfaces.

An agent can deliver an audio-based message in one of three modes: direct mode, assured mode, or secure mode. In direct mode, as soon as the recipient's access-unit goes off-hook, the message is played. In assured mode, when the recipient answers, the system prompts the user to enter a certain key prior to playing the message (this ensures the message is played to a person and not a machine). In secure mode, the system prompts the recipient to enter a secure pin prior to playing the message.

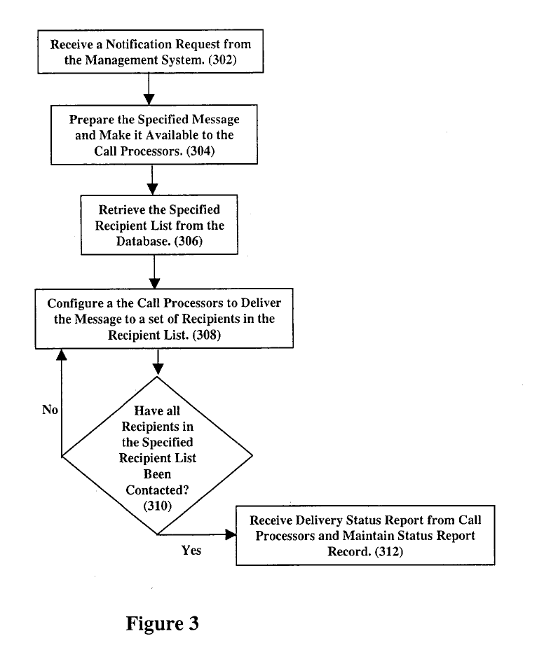

FIG. 3 shows the process followed by the notification processor 204 when receiving a notification event. In step 302, the notification processor receives a multicast request from the management system. Once notified, the notification processor in step 304 prepares the message specified in the multicast request (e.g., decompresses the message) and makes it available to the call processors 210. In step 306, the notification processor retrieves from the database 206 the recipient list 208 specified by the management system in the multicast request. Then, in step 308 the notification processor configures one or more call processors 210 with a recipients' phone numbers 226 and the delivery mode to be used for delivering the message, thereby causing the call processors to simultaneously establish calls to the indicated recipients and deliver the message.

Note that there may be more recipient numbers in the specified recipient list than available call processors 210. In this case, the notification processor instructs the call processors to establish calls and deliver the message to the indicated recipients in one or more call-waves (steps 308 and 310). In particular, the notification processor configures the call processors to establish a first wave of calls and deliver the message, then a second wave of calls, etc. The call processor determines which recipients are contacted during the first wave using a random method or using a predetermined order. In the latter case, each entry in a recipient list has a priority indication 230, as shown in exemplary subscriber list 222. The notification processor 204 uses this priority indication to determine which recipients should be contacted during the first wave, etc.

Each call processor 210 may report to the notification processor 204 whether the message was successfully delivered to a recipient (e.g., was a busy signal received). If notified, the notification processor maintains a record of all recipients that were successfully notified and not notified (step 312). Depending on the user preference, the management system 120 may later poll each agent for a delivery status update.

Turning to the data network 126, it provides interconnectivity between the management system 120 and agents 122/124. The type of data network used for interconnectivity is not specific to our invention. As such, the network can include a PSTN-based network, such as the CCS/SS7 signaling network. This network offers assured packet delivery with high reliability and low latency. However, this network can be cumbersome to interface with. Preferably, the data network is an IP (Internet Protocol) based network (such as IP over frame relay, IP over Ethernet, etc.). Readily available interface components exist for interfacing to these networks. These networks also provide low latency data transfers.

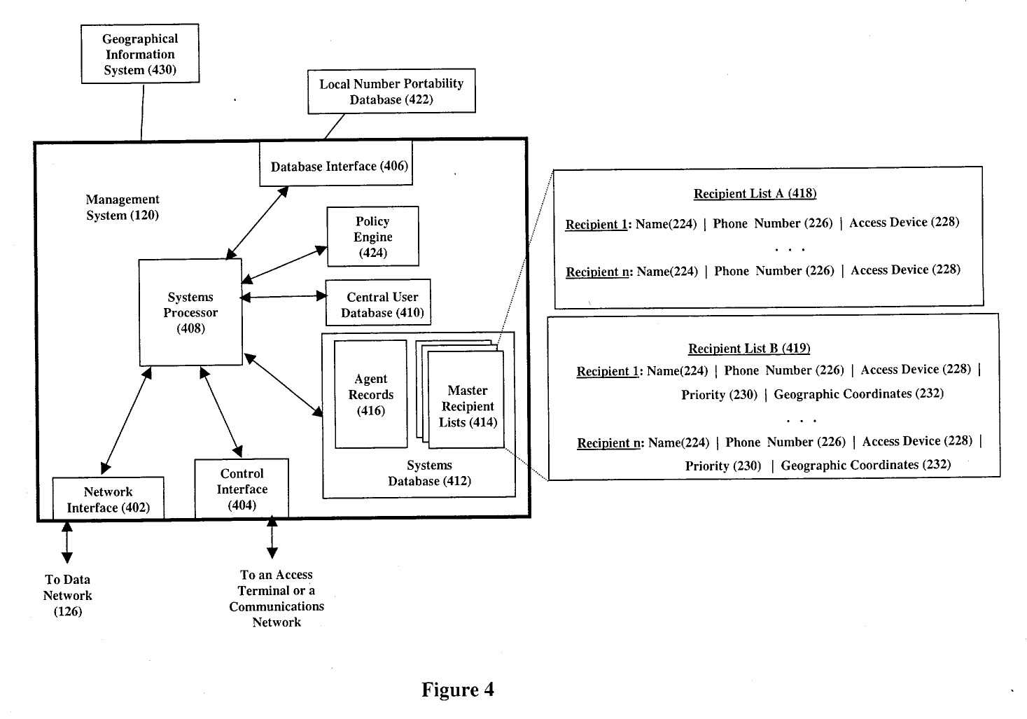

FIG. 4 is a diagram of management system 120. The management system comprises a network interface 402 for interfacing the data network 126, a control interface 404, a database interface 406, a systems processor 408, a central-user database 410, a systems database 412 comprising a plurality of master recipient lists 414 and agent records 416, and a policy engine 424. As indicated, a notification initiator interacts with the management system to specify a notification message and a master recipient list that should receive the message (Similarly, the notification initiator may specify an indication of which master recipient list 414 should be used. Here, the management system correlates the indication with the master recipient lists to choose a list). Once having the desired master recipient list, the management system determines which agents have sub-lists comprising the chosen list and sends a multicast request to these agents (the multicast request specifying the notification message, an indication of the master recipient list, and a delivery mode). Upon receiving the notification request, the agents deliver the message to the specified recipients as described above.

As indicated, system 100 resides within the PSTN network. However, as is known, the PSTN comprises a plurality of service providers, each with a corresponding set of end-office switches/tandems, etc. The agents 122/124 are preferably deployed on a per service provider basis, with the agents being connected to the end-office switches within each service provider's network. In accordance with our invention, a single management system 120 preferably oversees and controls the agents within each service provider's network. However, for larger service providers, more than one management system may be used. Here, the end-office switches/agents are broken into two or more groups and each group is assigned a management system.

The agent's associated with a given management system can be viewed as a single domain controlled by that management system. Similarly, the recipients associated with a management system's agents can be viewed as being part of the management system's domain. Accordingly, when a notification initiator accesses a management system to initiate a notification event, that single management system can multicast the message to all recipients in its domain.

Through agent records 416, the management system maintains a record of the agents within its scope of control/domain. In particular, the management system maintains each agent's network address on the data network 126. In addition, and as is known, each of the end-office switches within a service provider's network has a unique NPA-NXX code. Accordingly, each agent is associated with one or more NPA-NXX codes. The management system also maintains in the agent records 416 an indication of these NPA-NXX codes for each of its associated agents.

The management system communicates with its assigned agents through network interface 402, which is a standard communications interface connected to data network 126 and is dependent on the specific type of data network 126. The control interface 404 is either a data network interface or a terminal access interface. List administrators and notification initiators access control interface 404 to configure the management system and to initiate notification events. Note that when control interface 404 is a data network interface, it may be the same interface as interface 402. In addition, when control interface 404 is a data network interface, users preferably access the management system through a web-based interface.

The management system uses database interface 406 for communicating with support systems, which are maintained either by the management system's corresponding service provider or by a third party. Specifically, the management system uses this interface to access a local number portability database (LNP) 422 to obtain location routing numbers (LRNs) for ported numbers. In particular, due to local number portability, a recipient's phone number may not indicate the actual end-office switch that serves the recipient. One intent of system 100 is to avoid having the agents make inter-office calls during a notification event. As such and as further described below, the management system needs to associate a recipient to the agent that interfaces the end-office switch that actually serves the recipient. The LNP database 422 assists in this determination.

Prior to a notification event, list administrators (either actual subscribers or a system administrator) access the control interface 404 and configure the management system with information corresponding to the recipients within the management system's domain. The management system stores this information in central-user database 410. The entered/stored information includes the name and phone-number of each recipient and may also include the recipient's access device. As an example, central-user database 410 may be a conventional ENUM (“telephone number mapping”) database, in which case the recipient information can be entered through a conventional ENUM secure registration application. As recipient information is entered, the management system accesses the LNP database 422 to obtain the LRN for any ported phone-number. As indicated earlier, by knowing a recipient's LRN, the management system can use the corresponding NPA-NXX code to properly associate the recipient to the agent connected to the recipient's serving switch. As a result, when a notification event occurs, the management system can instruct this agent to contact the recipient and avoid having the agent make inter-office calls that would subsequently result if the number had not been pre-ported. Once the central-user database 410 is populated, the management system sorts the database using the NPA-NXX codes of the recipients' phone-numbers or LRN's.

Once the central-user database 410 is populated and sorted, the actual master recipient lists 414 can be formed. These lists, in addition to the populating of the central-user database 410, are created during a maintenance process prior to a notification event. As indicated above, the types of lists are not particular to system 100. A list administrator (either an individual that needs to send notifications—like the fire department—or a system administrator) accesses the management system (in particular, the central-user database 410) and selects specific recipients (through names, numbers, etc.) to form a master recipient list. This list is stored in systems database 414. Once formed, the management system then groups the recipients within this list into one or more sub-lists based on, for example, the NPA-NXX codes of the recipients' numbers/LRN and sends each sub-list to its corresponding agent based on, for example, the list's NPA-NXX code. In addition, the management system maintains an association between the master recipient list and the agents within its domain that have a corresponding portion of this list. Note also that the management system may convey list-update messages to an agent. In particular, a list administrator may add or remove recipients from any given list causing the management system to update the list in the systems database 412 and causing the management system to convey the change to the corresponding agent. (See FIG. 2B for an exemplary diagram showing the relationship between the recipient lists maintained at the management system and agents.).

As indicated above and as shown in exemplary lists 418 and 419, the information maintained in any given recipient list includes the recipient's name 224, ported phone number 226, and may also include the recipient's access device 228. Each entry may also include a priority indication 230, which, as described above, an agent uses to determine which recipients within a given recipient list should be notified first. Priority indications are determined and specified when a list administrator creates the lists.

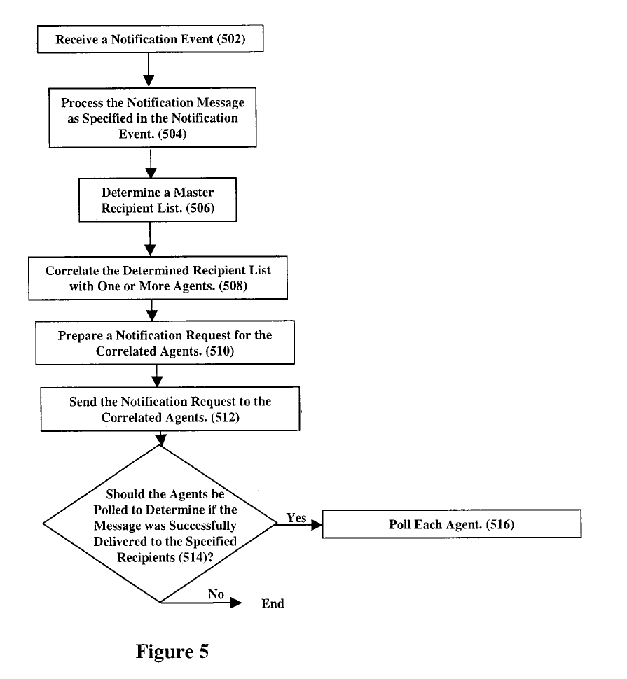

The final component of the management system 120 is systems processor 408, which oversees the operation of the management system during a notification event as shown in FIG. 5. To initiate a notification event, a notification initiator (either an individual that needs to send notifications—like the fire department—or a system administrator) accesses the management system 120 through the control interface 404 and specifies a notification event (step 502). The notification event includes a message/message type, an actual master recipient list or criteria for identifying a list, and may also include a delivery mode (the modes were described above and include direct mode, assured mode, or secure mode).

Based on the specific message/message type specified in the notification event, the systems processor in step 504 processes this message. Depending on the type of message, this step may include accessing a pre-recorded message on the management system, designating that a pre-recorded message or ring pattern on the agent be used, or collecting an audio/text message from the user. In the latter case when the message is an audio-based message, the control processor converts the message to a digital format, if this function was not previously performed, and compresses the message (for example, an 8:1 compression ratio can be used). Note that because audio-based message are supported, the management system may also comprise a digital-to-analog converter for converting a user entered audio message to a digital format.

In step 506, the systems processor analyzes the recipient criteria as specified in the notification event and determines which master recipient list 414 meets these criteria. Again, either an actual list can be specified or an indication of a list. In the latter case, the systems processor may use policy engine 424 to choose a list that matches the criteria. Policy engine 424 uses a set of predetermined rules to translate a user's general criteria as to scope of a notification into a specific recipient list.

In step 508, the systems processor correlates the determined recipient list with the one or more agents that have sub-lists comprising this list. In step 510, the systems processor prepares a multicast request for these identified agent(s). The multicast request includes an indication of the determined master recipient list (again, an indication of the list rather than the list itself is specified and the indication may be a list name, etc.), the actual message or a message indication (if the message is pre-stored at the agent), and a delivery mode. Lastly, in step 512, the control processor sends the multicast request over the data network 126 to the identified agent(s), causing each agent to use the indicated list to locate its local recipient list and deliver the specified message to the listed recipients as described above. Based on user preference (step 514), the systems processor may also poll (step 516) each agent at a later time to determine which recipients did and did not successfully receive the message.

As indicated, an objective of system 100 is to quickly deliver the notification message to recipients. Accordingly, if the systems processor 408 identifies numerous agents in steps 506/508, the data network 126 may become a bottleneck as the systems processor attempts to transmit the multicast request to the agent(s) in step 512. In these cases, the systems processor overcomes this bottleneck by conveying the multicast request to the agents in several phases. Specifically, once the systems processor correlates the determined recipient list to the agents in step 508, the systems processor categorizes the agents into several phases. The intent is for the systems processor to send the multicast request to the agents identified in the first phase. The first phase agents then send the multicast request to the agents identified in the second phase (i.e., each first phase agent has a set of agents it communicates with). The second phase agents then send the multicast request to the agents identified in the third phase, etc. For example, the control processor may send the multicast request to twenty-eight agents. Each of these twenty-eight agents may then send the multicast request to another twenty-eight agents, etc. The advantage of this phased distribution is that the sending of the multicast request occurs from several points throughout the data network 126 rather than from a single point at the management system 120.

In this embodiment of our invention, the management system 120 may also interface a geographical information system (GIS) 430, as shown in FIG. 4. Here, each entry in the master recipient lists 414 of systems database 412 and each entry in the recipient lists 208 of database 206 can have geographic coordinates 232 associated with it (i.e., the geographic location of each recipient can be maintained). These geographic coordinates of each recipient are entered when a recipient's information is entered into database 410. In accordance with this embodiment of our invention, when a notification initiator specifies criteria for identifying a recipient list (step 502), the initiator also uses the GIS system to identify a geographic location. Like above, the systems processor uses the entered criteria to select a master recipient list and again, identifies the corresponding agents. However, when sending the multicast request to the agent(s,) the system processor also includes the geographic location selected through the GIS system. At each agent, rather than send the message to all recipients on the identified list, the agent compares a recipient's geographic coordinates with those indicated in the multicast request and notifies only those recipients within the specified scope.

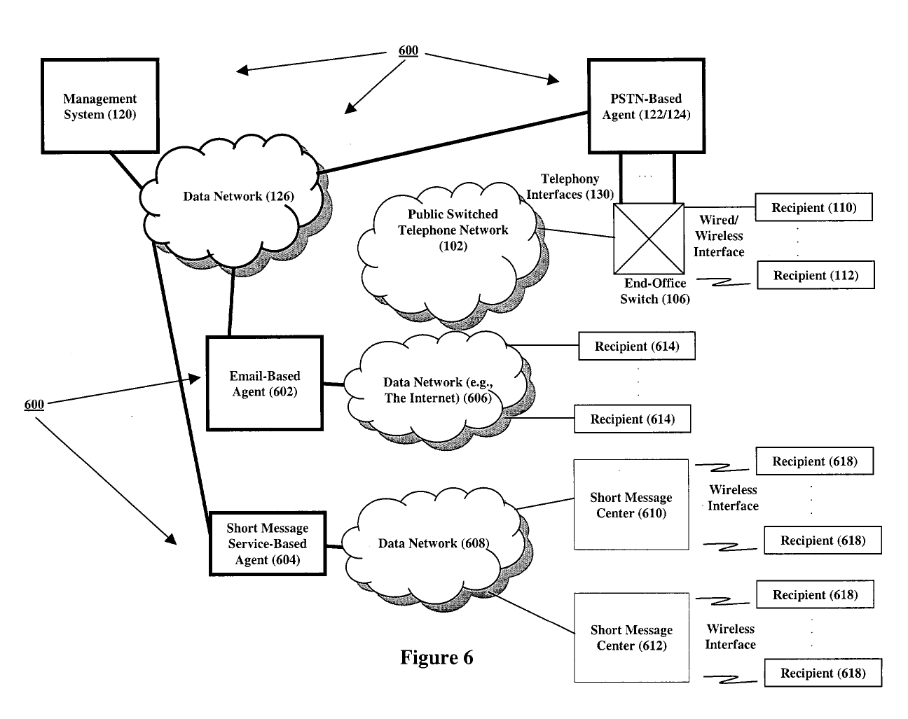

FIG. 6 shows a second embodiment of our invention. Similar to the embodiment shown in FIG. 1, notification system 600 comprises a management system 120, a data network 126, and a plurality of agents 122/124 (referred to as PSTN-based agents in FIG. 6 for clarity) for multicasting a notification message to a plurality of PSTN-based recipients using the PSTN network 102. In addition, system 600 also comprises one or more email-based agents 602 for multicasting the notification message to email-based subscribers 614 (referred to as recipients) and short message service (SMS) based agents 604 for multicasting the message to SMS-based subscribers 618 (again, referred to as recipients). Importantly, system 600 is shown as a unified system where a single management system 120 is able to initiate the multicasting of a message to recipients 110, 112, 614, and 618 through varying media types. However, system 600 may also exist in its constituent parts with a dedicated management system controlling PSTN-based agents (as described above), a dedicated management system controlling email-based agents, and a dedicated management system controlling SMS-based agents or any combination thereof.

For email-based notification, system 600 comprises one or more email-based agents 602. These agents are interfaced to a data network 606, such as the Internet, for notifying recipients 614 via email. Similar to the first embodiment, each email-based agent 602 is assigned a set of recipients 614, which the agent is responsible for notifying during a notification event. Recipients can be categorized and assigned to an agent 602 based on the recipient's physical location or based on the recipient's service provider, for example. However, the categorizing of email-based recipients 614 is not specific to our invention.

Similar to above, list administrators configure the management system 120 with information corresponding to the email-based recipients 614, in particular, each recipient's email address. A list administrator then creates one or more master recipient lists 414 that may include email-based recipients. Like above, each list is then decomposed into sub-recipient lists, including email-based recipient lists, which in particular are forwarded to corresponding email-based agent(s) 602 based on which agent is responsible for sending messages to those recipients.

Each email-based agent 602 comprises a standard network interface for accessing data network 606 and standard mechanisms for launching email messages. Each agent 602 also comprises a database for storing its recipient lists and a notification processor. Similar to above, the notification processor receives a multicast request from the management system via data network 126 and uses the email mechanisms to send the notification message to the indicated recipients.

Specifically, when a notification event occurs, the management system sends the multicast request to the email-based agent(s), like above. Again, the multicast request includes a message and a recipient list indicator designating which recipient list the agent should use. Again, the message can be a text or audio message, or an indication of a message previously stored at the agent. Note that audio messages are sent in the email as an attachment file. If a text message needs to be sent and the notification initiator provides an audio message, the management system converts the audio message to a text format.

For SMS-based notification, system 600 comprises one or more SMS-based agents 604. Each agent is interfaced to one or more short message centers (SMC) 610/612, which are located in the service provider's network. An agent 604 may interface an SMC through a data network 608, for example. Here, the agent delivers to the SMC a message and an intended recipient, and then allows the SMC to deliver the message to this recipient, as in known in the art.

Again, each SMS-based agent 604 is assigned a set of recipients 618, which the agent is responsible for notifying during a notification event. Recipients can be categorized and assigned to an agent 604 based on the recipient's serving switch, for example. However, the categorizing of SMS-based recipients 618 is not specific to our invention. Depending on the recipients assigned to the SMS-based agent 604, the agent may communicate with one or more SMC's across one or more service providers.

Each SMS-based agent 604 comprises a standard network interface for accessing data network 608 and standard mechanisms for communicating with an SMC. Each agent 604 also comprises a database for storing its recipient lists and a notification processor. When a notification event occurs, the management system sends the multicast request to the SMS-based agent(s) via data network 126. Based on the multicast request, the notification processor accesses the appropriate recipient list from its database and sends a text message to these recipients through the SMC's. Note that similar to the SMS-based agent and SMC's, system 600 can also send notification messages through pager networks to pager-type recipients.

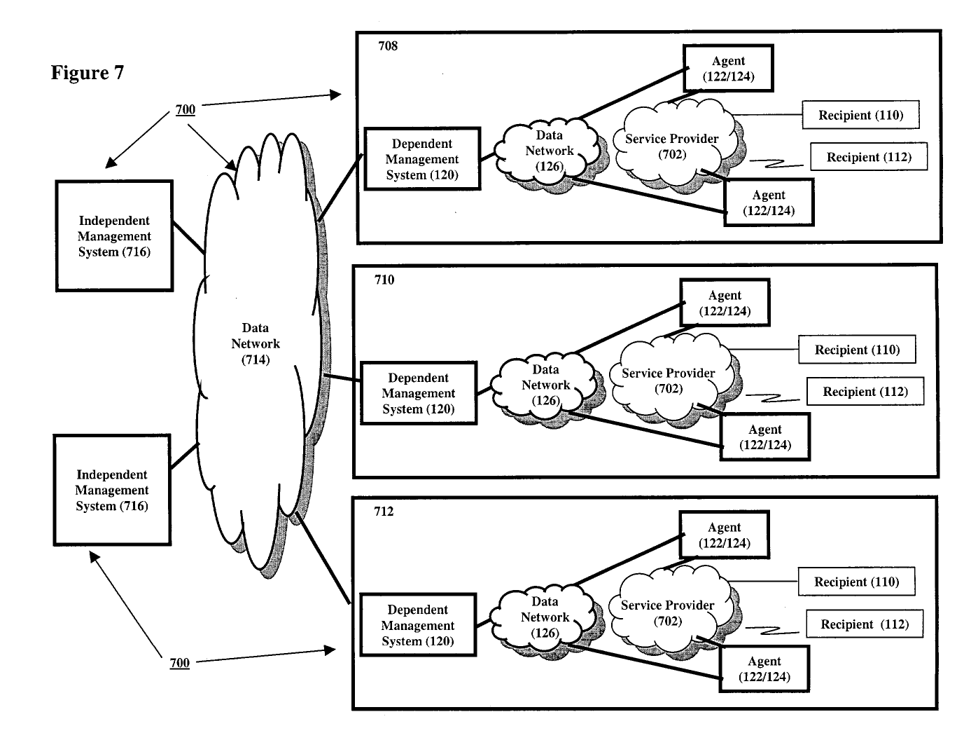

FIG. 7 shows a third embodiment of our invention for addressing large-scale notification events. Specifically, when large-scale notifications are required, a notification initiator may need to access several management systems 120 to reach the desired set of recipients. This is because system 100 is preferably deployed on a service provider basis, with each service provider's network containing a corresponding set of PSTN-based agents 122/124 controlled by a distinct management system 120. Similarly, for larger service providers, the provider's network may be sub-divided into several regions each with a corresponding set of agents and a management system. In addition, as was described for system 600, a distinct management system may control each of the PSTN-base agents 122/124, email based agents 602, and SMS-based agents 604.

This third embodiment of our invention is directed at allowing a notification initiator to efficiently notify a plurality of recipients across several systems. Specifically, system 700 comprises a plurality of sub-notification systems 708, 710, and 712 each of which is of the first or second embodiments discussed above. As such, each sub-notification system 708, 710, and 712 comprises a set of agents 122/124 controlled by a distinct management system 120. Note that for ease of description, only PSTN-based agents are shown. Each sub-notification system 708, 710, or 712 may correspond to a unique service provider 702, 704, and 706 or to a sub-divided service provider as described. In system 700, each management system 120 can be referred to as a “dependent management system.” Importantly, each system 708, 710, and 712 continues to operate as above. In other words, a notification initiator can directly access a dependent management system 120 through the control interface and multicast a message to a set of recipients within that management system's domain of control.

System 700 further comprises a plurality of independent management systems 716, each operated by an organization (e.g., a state or federal government organization) that needs to notify recipients spread over multiple service providers, and comprises a data network 714 that interconnects the independent management systems 716 to the dependent management systems 120. The dependent management systems interface the data network 714 through control interface 404, for example, and like above, data network 714 is not specific to our invention.

The structure of the independent management system 716 resembles the structure of the dependent management system 120 as shown in FIG. 4. Specifically, the independent management system comprises a control interface for user interaction, and a network interface for interfacing with data network 714. The independent management system may also comprise a database interface for communicating with the support systems, such as LNP databases. The system further comprises a central user database for storing recipient information and a systems database for storing master recipient lists, as shown in FIG. 4. Importantly, the independent management system does not maintain any information on the agents within a dependent management system's domain nor the specific makeup of a service provider's network. The independent management system also comprises a policy engine for discerning a recipient list based on entered criteria and may comprise a GIS system.

The recipient lists for system 700 are created similar to above. During a maintenance process, a list administrator accesses the independent management system and enters recipient information into the central user database. Importantly, the independent management system needs to determine which dependent management system covers the domain in which the recipient is located also taking into account that the recipient's number may be ported. The independent management system makes this determination either dynamically, by accessing a LNP database, or based on information entered by the list administrator.

Once subscriber information is entered in the central user database, a list administrator accesses the independent management system and selects specific recipients to form a master recipient list. This list is stored in the systems database. Once formed, the independent management system then groups the recipients within this master list into one or more sub-lists based on the domain of the dependent management systems (i.e., recipients are sorted based on which sub-notification system covers the recipients) and sends each sub-list to is corresponding dependent management system. In addition, the independent management system maintains an association between the master recipient list and the dependent management systems that have a corresponding portion of this list.

Upon receiving a list, a dependent management system stores the list in its systems database 412 as a master recipient list and then subdivides the specified recipients into a new set of sub-lists based on the scope of each agent within the dependent management system's domain. The dependent management system then maintains an association between this master recipient list and the agents that have a corresponding portion of the list. Lastly, a copy of each sub-list is sent to its corresponding agent based on which agent serves the recipients. Importantly, each independent management system 716 creates its own set of master recipient lists and as such, each sub-notification system 708, 710, and 712 maintains portions of each of these lists. Note also that users may continue to directly access dependent management systems 120 to create recipient lists at this level.

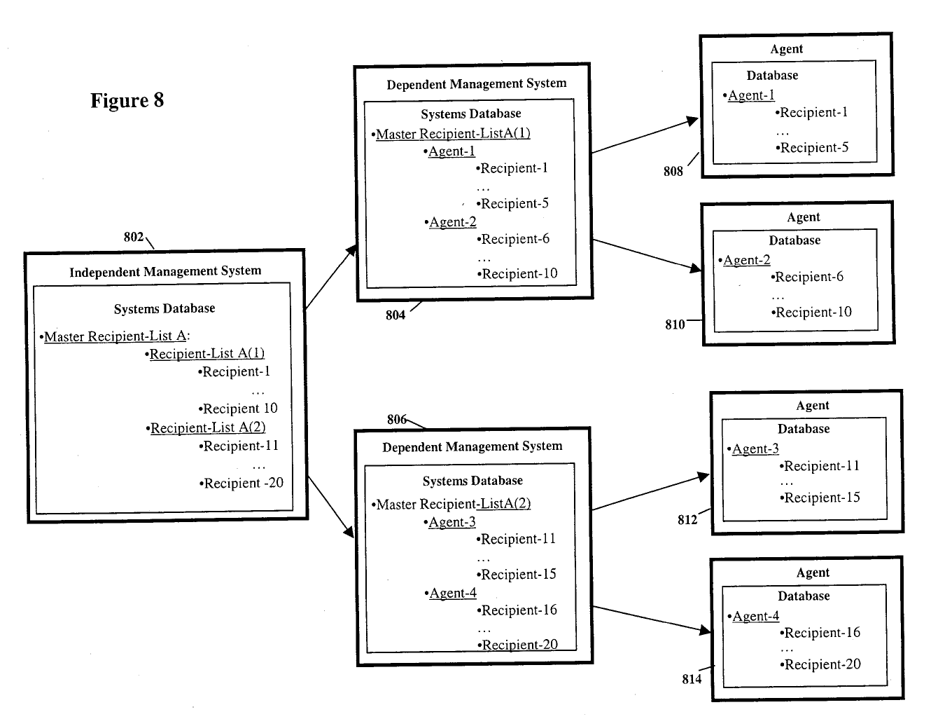

FIG. 8 is an exemplary diagram showing the relationship between the recipient lists for the embodiment of FIG. 7. Independent management system 802 contains a “Master Recipient-List A” that comprises two component lists, “Recipient-List A(1)” and “Recipient-List A(2),” each specifying a set of recipients 1-10 and 11-20 respectively (Note that for example reasons only, the master list at independent management system 802 is shown as being stored as/composed of the individual sub-lists. However, how the master list is stored/arranged is not specific to our invention). Recipient-List A(1) corresponds to dependent management system 804 and Recipient-List A(2) corresponds to dependent management system 806. Accordingly, the independent management system sends each of these component lists to its corresponding dependent management system. Upon receiving Recipient-List A(1), dependent management system 804 stores it as Master Recipient-List A(1) and decomposes/sorts the list of recipients 1-10 into a further set of lists, “Agent-1” and “Agent-2,” based on which agent serves the designated recipients (again, how the list is arranged/stored is not specific to our invention). Dependent management system 804 then maintains an association between “Master Recipient-List A(1)” and agents 808 and 810. Finally, the “Agent-1” list and “Agent-2” list are forwarded to agents 808 and 810 respectively. A similar process occurs at dependent management system 806 and agents 812 and 814.

Using FIG. 8 as an example, a notification initiator notifies a set of recipients through system 700 by accessing independent management system 802 and specifying a notification message/message type and criteria identifying a master recipient list (or the list itself). Similar to above, the independent management system correlates the criteria to the master recipient lists to identify the intended list. Assuming independent management system 802 identifies “Master Recipient-List A” based on the entered criteria, the system sends a multicast request to dependent management system 804 and 806. Regarding system 804, the multicast request includes the message and an indication of “Master Recipient-List A.” Upon receiving this multicast request, dependent management system 804 correlates the list indication to “Master Recipient-List A(1)” and to agents 808 and 810. Dependent management system 802 then sends a multicast request to agents 808 and 810, specifying the message and an indication of lists “Master Recipient-List A(1). Each agent 808 and 810 then accesses its corresponding list (“Agent 1” or “Agent 2”) from its database and sends the message to the specified recipients. A similar process occurs at dependent management system 806 and agents 812 and 814.

It should be noted that our inventive systems 100, 600, and 700 were described with respect to emergency-type notifications. However, our invention can also be used to multicast other types of information to recipients including advertisements, etc.

The above-described embodiments of our invention are intended to be illustrative only. Numerous other embodiments may be devised by those skilled in the art without departing from the spirit and scope of our invention.

We claim:

1. A system for multicasting a message to subscribers of a telephony system wherein the telephony system comprises a plurality of switches each serving a set of the subscribers, said system comprising:
a plurality of agents each associated with a switch and comprising a plurality of recipient lists wherein each list specifies one or more subscribers served by the end-office switch to which the agent is associated,
a data network for transmitting multicast requests to the agents, and
a management system connected to the data network and comprising:
a plurality of master lists wherein each list comprises subscribers from one or more of the recipient lists maintained by one or more of the agents,
means for determining a master list from among the plurality of master lists, and
means for conveying, through the data network, a multicast request to the agents that are associated with the determined master list.

2. The system of claim 1 wherein each entry of the recipient lists comprises the phone-number of the corresponding subscriber and wherein the management system further comprises means for accessing a local number portability database to resolve ported subscriber numbers such that each agent maintains lists of subscribers served by the switch to which the agent is associated.

3. The system of claim 1 wherein each entry of the recipient lists comprises a priority indicator, wherein the agents use the priority indicator for sending the message to subscribers in a plurality of call waves.

4. The system of claim 1 wherein each agent further comprises means for correlating the determined master list received in the multicast request to one of its plurality of recipient lists.

5. The system of claim 1 wherein each entry of the recipient lists comprises geographical coordinates and wherein the agents use the geographical coordinates for sending the message to a subset of the subscribers specified within the one of its plurality of recipient lists corresponding to the determined master list.

6. The system of claim 1 further comprising:
one or more email-based agents connected to the management system through the data network and comprising a plurality of email-based recipient lists wherein each list specifies one or more email subscribers, and
wherein one or more of the master lists at the management system comprises email subscribers from one or more of the recipient lists maintained by the one or more email-based agents.

7. The system of claim 6 further comprising:
one or more short message service (SMS) based agents connected to the management system through the data network and comprising a plurality of SMS-based recipient lists wherein each list specifies one or more SMS subscribers, and
wherein one or more of the master lists at the management system comprises SMS subscribers from one or more of the recipient lists maintained by the one or more SMS-based agents.

8. The system of claim 1 wherein the switches include end-office switches and tandem switches and wherein at least one of the plurality of agents is associated with a plurality of end-office switches through a tandem switch and wherein the plurality of recipient lists at the at least one agent comprises recipient lists for each of the plurality of end-office switches.

9. The system of claim 1 wherein at least one of the switches is a PBX and wherein at least one of the plurality of agents is associated with the at least one PBX.

10. A system for multicasting a message to a plurality of recipients, each recipient being associated with one or more of a plurality of communication networks, said system comprising:
a plurality of agents, each agent being associated with a specific group of recipients and comprising means for conveying the message to the specific group of recipients,
a plurality of dependent management systems, each management system being associated with a distinct set of agents from the plurality of agents and comprising means for conveying the message through a data network to its agents, and
an independent management system comprising means for conveying the message to the plurality of dependent management systems,
wherein each agent comprises a plurality of recipient lists wherein each list specifies one or more recipients from among the agent's specific group of recipients, wherein each dependent management system comprises the recipient lists maintained by each of its associated agents, and wherein the independent management system comprises a set of the recipients lists maintained by each of the dependent management systems, and,
wherein the independent management system initiates the multicasting of the message to the plurality of recipients through the dependent management systems and agents.

11. The system of claim 10 wherein the independent management system initiates the multicasting of the message based on its recipient lists and wherein the independent management system multicasts the message to a subset of the one or more dependent management systems and to a subset of the agents associated with the subset of dependent management systems.

12. A method for multicasting a message to subscribers of a telephony system wherein the telephony system comprises a plurality of end-office switches serving the subscribers, said method comprising:
receiving at a management system an indication,
using the indication to choose from among a plurality of master recipient lists one master recipient list,
determining from among a plurality of agents which agents are associated with the chosen master recipient list,
conveying a multicast request to one or more of the determined agents wherein the multicast request comprises an indication of the chosen master recipient list, and
wherein each multicast request causes an agent to access a list that is associated with the master recipient list indicted in the multicast request and to send the message to the subscribers specified within the accessed list.

13. The method of claim 12 wherein each agent receiving the multicast request further conveys the multicast request to one or more of the determined agents.

14. The method of claim 12 further comprising prior to the receiving step the steps of:
receiving a plurality of subscriber information, and
using the plurality of subscriber information to create the plurality of master recipient lists.

15. A method for multicasting a message to a plurality of recipients wherein each recipient is associated with a communications network, said method comprising:
receiving at an agent a multicast request, wherein a management system generated the multicast request by choosing from among a plurality of master recipient lists a single master recipient list and by determining that the agent is associated with the single master recipient list, and wherein the multicast request comprises an indication of the single master recipient list,
accessing a list associated with the indicated single master recipient list, and
establishing communications with recipients specified in the accessed list to deliver the message.

16. The method of claim 15 wherein each entry of the accessed list comprises a priority indicator and wherein the establishing step further comprises the step of using the priority indicator to establish the communications and deliver the message to the specified recipients in a plurality of call waves.

17. The method of claim 15 wherein each entry of the accessed list comprises geographical coordinates and wherein the establishing step further comprises the steps of:
using the geographical coordinates to determine a subset of the recipients specified in the accessed list, and
establishing communications with the subset of determined recipients to deliver the message.

18. The method of claim 15 wherein the message is an audio message and wherein the receiving step further comprises receiving the audio message as part of the multicast request.

19. The method of claim 15 wherein the establishing step further comprises the steps of:
prompting for a response, and
delivering the message once the response is received.

20. The method of claim 15 wherein the establishing step further comprises the step of simultaneously establishing communications with a plurality of the recipients specified in the accessed list to deliver the message.

21. The method of claim 15 further comprising after the establishing step the step of recording for each recipient specified in the accessed list whether the message was successfully delivered.

22. A method for multicasting a message to a plurality of recipients wherein each recipient is associated with a communications network, said method comprising:
receiving at an independent management system an indication,
using the indication to choose from among a plurality of maser lists to a single master list,
determining from among a plurality of dependent management systems which dependent management systems are associated with the chosen master list,
conveying a multicast request to the determined dependent management systems
wherein the multicast request comprises an indication of the chosen master list, and
wherein the multicast request causes a dependent management system to determine from among a plurality of associated agents which agents are associated with the master list indicated in the multicast request and to convey a second multicast request to the determined agents, and
wherein the second multicast request causes an agent to access a recipient list and to send the message to the recipients specified within the accessed list through each recipient's associated communications network.

23. A system for multicasting a message to a plurality of subscribers, groups of said subscribers being connected to one or more communication networks, said system comprising:
a management system,
a data network connected to said management system, and
a plurality of agents, each associated with a specific group of subscribers, associated with a different communication element in said one or more communication networks and receiving the message for its specific group of subscribers from said management system through said data network independent of said one or more communication networks,
said management system including means for maintaining agent records and subscriber lists, and means for correlating a subscriber indication to the subscriber lists to determine which agents receive the message, and
each of said agents including means for maintaining a subscriber list, a call processor, and a notification processor.

24. The system in accordance with claim 23 wherein said one communication network is a switched telephone network and said communication element in said one communication network to which one of said agents is associated is a telephone switching office.

25. The system in accordance with claim 24 wherein said telephone switching office is an end office to which subscribers are connected.

26. The system in accordance with claim 24 wherein said telephone switching office is a tandem office and further comprising a plurality of end offices to which subscribers are connected.

27. The system in accordance with claim 23 wherein one of said agents is an email based agent and said one communication network is a second data network.

28. The system in accordance with claim 23 wherein one of said agents is a short message based agent and said one communication network is a second data network.

29. The system in accordance with claim 23 wherein said subscriber list in each of said agents includes subscriber names and telephone numbers.

30. The system in accordance with claim 29 wherein said subscriber list in at least some of said agents further includes a priority indication for each of the subscribers.

31. The system in accordance with claim 24 further comprising means connected to said management system for providing to said management system location routing numbers for subscribers whose phone number does not indicate the actual telephone switching office for that subscriber.

32. The system in accordance with claim 29 further comprising a geographical information system connected to said management system and wherein said subscriber list in at least some of said agents includes geographic coordinate information.

33. A method for multicasting a message to a plurality of subscribers connected to telephone switching offices in a communications network, said method comprising the steps of
receiving in a management system notification of a message to be sent,
determining a recipient list specifying a set of subscribers that matches criteria in the received message,
correlating the recipient list so determined with an agent associated with its connected telephone switching office, and
sending the message to each such correlated agent independent of the telephone switching offices.

34. The method in accordance with claim 33 wherein said step of sending the message to said correlated agents comprises sending the message through a data network to which the management system and the agents are both connected.
